(19) United States
(12) Patent Application Publication
(10) Pub. No.: US 2007/0119291 A1
(43) Pub. Date: May 31, 2007

(54) Musical performance training device and recording medium for storing musical performance training program

(75) Inventor: Hiroshi Morokuma, Fuchu-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Casio Computer Co., Ltd., Tokyo (JP)

(21) Appl. No.: 11/602,655

(22) Filed: Nov. 21, 2006

(30) Foreign Application Priority Data
Nov. 25, 2005 (JP) 2005-339557

(51) Int. Cl. G10H 7/00; A63H 5/00; G04B 13/00

(52) U.S. Cl. 84/609

(57) ABSTRACT

In a musical performance training device according to the present invention, song data indicating each sound composing a song and including a step that indicates a training mode (self-running mode or wait mode) for each sound is read. When the read song data is in self-running mode, the reading of the song data is continued, regardless of whether the key to which a user is guided by the illumination of the LED is pressed. When the read song data is in wait mode, the song process is temporarily stopped at a sounding timing of the key to which the user is guided by the illumination of the LED. The song data of the next sound is read upon the pressing of the key to which the user is guided.

### CROSS-REFERENCE TO RELATED APPLICATION

This application is based upon and claims the benefit of priority from the prior Japanese Patent Application No. 2005-339557, filed Nov. 25, 2005, the entire contents of which is incorporated herein by reference.

### BACKGROUND OF THE INVENTION

1. Field of the Invention

The present invention relates to a musical performance training device suitable for use in an electronic musical instrument including a keyboard and a recording medium to which a musical performance training program is recorded.

2. Description of the Related Art

In the field of electronic musical instruments, a device that provides musical performance training to a player by guiding the player to the key to be played is known. The device guides the player by illuminating a light-emitting diode (LED) that is mounted on the key of a pitch to be sounded, among the LED provided for each key on the keyboard, in correspondence with a sounding timing at which the pitch is sounded. The device illuminates the LED based on song data indicating the pitch to be sounded and the sounding timing.

As this type of device, for example, the following device is disclosed in Japanese Laid-open Patent Publication No. 2000-206965. The device has a training mode in which, when the key to which a player is guided is not pressed even after the elapse of the sounding timing, the reading of the song data is stopped until the key to which the player is guided is pressed. The device also has a training mode in which, when the key to which the player is guided is pressed before the sounding timing, the song data is fast-forwarded to the sounding timing. In other words, a device that changes training modes depending on the timing at which the key to be played is pressed is disclosed.

However, there is a problem in that the training mode cannot be set for each sound composing the song and detailed musical performance training cannot be actualized by merely the training mode being changed, such as the reading of the song data being stopped or the song data being fast-forwarded, depending on the timing at which the key to be played is pressed, as in the device disclosed in the above-described Japanese Laid-Open Patent (Kokai) Publication No. 2000-206965.

### SUMMARY OF THE INVENTION

The present invention was achieved in light of the above-described issues. An object of the present invention is to set a training mode of each sound composing a song and actualizing detailed musical performance training.

In accordance with an aspect of a musical performance training device according to the present invention, data indicating each sound composing a song and a training mode of each sound is read in an instructed reading mode, and a user is guided to the key to be played according to the read song data. Simultaneously, the reading mode of a next song data is instructed according to the training mode indicated by the song data. In other words, the song data is successively read in a reading mode according to the training mode specified within the song data, and the user is guided to the key to be played.

In accordance with another aspect of the present invention, song data indicating a pitch and sounding timing of each sound composing a song and a training mode of each sound is read according to a reading instruction. The user is guided to the position and the pressing timing of the key to be played according to the pitch and sounding timing of the sound indicated in the read song data. When the read song data indicates a first training mode, the reading of the song data of the next sound is instructed, regardless of whether the key to which the user is guided is pressed. When the read song data indicates a second training mode, the reading of the song data is temporarily stopped at the key-pressing timing of the key to which the user is guided. The reading of the song data of the next sound is instructed upon the pressing of the key to which the user is guided.

In accordance with still another aspect of the present invention, song data indicating each sound composing a song is read in an instructed reading mode, and a user is guided to the key to be played according to the read song data. Simultaneously, the reading mode of a next song data is instructed according to the training mode designated by user operation. In other words, the song data is read in the reading mode according to the training mode designated by the user operation, and the user is guided to the key to be played.

In accordance with still another aspect of the present invention, song data indicating a pitch and sounding timing of each sound composing a song is read according to a reading instruction. The user is guided to the position and the pressing timing of the key to be played according to the pitch and sounding timing of the sound indicated in the read song data. When the a first training mode is designated by user operation, the reading of the song data of the next sound is instructed, regardless of whether the key to which the user is guided is pressed. When a second training mode is designated by user operation, the reading of the song data is temporarily stopped at the key-pressing timing of the key to which the user is guided. The reading of the song data of the next sound is instructed upon the pressing of the key to which the user is guided.

In accordance with still another aspect of the present invention, song data indicating a pitch and sounding timing of each sound composing a song is read according to a reading instruction. The user is guided to the position and the pressing timing of the key to be played according to the pitch and sounding timing of the sound indicated in the read song data. When the a first training mode is designated by user operation, the reading of the song data of the next sound is instructed, regardless of whether the key to which the user is guided is pressed. When a second training mode is designated by user operation, the reading of the song data is temporarily stopped at the key-pressing timing of the key to which the user is guided. The reading of the song data of the next sound is instructed upon the pressing of the key to which the user is guided. When a third training mode is designated by user operation, the reading of the sound data of the next sound is instructed when the key to which the user is guided is pressed at the key-pressing timing.

The above and further novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

FIG. 1 is a block diagram showing a configuration of a musical performance training device according to a first embodiment of the present invention;

FIG. 2 is a diagram showing a song data configuration;

FIG. 3 is a flowchart showing operations of a main routine;

FIG. 4 is a flowchart showing operations of a switch process;

FIG. 5 is a flowchart showing operations of a start/stop switch process;

FIG. 6 is a flowchart showing operations of a guide process;

FIG. 7 is a flowchart showing operations of the guide process;

FIG. 8 is a flowchart showing operations of the guide process;

FIG. 9 is a flowchart showing operations of a key-pressing process;

FIG. 10 is a flowchart showing operations of the key-pressing process;

FIG. 11 is a flowchart showing operations of a switch processing according to a second embodiment;

FIG. 12 is a flowchart showing operations of a mode switch process according to the second embodiment;

FIG. 13 is a flowchart showing operations of a segment designation switch process according to the second embodiment;

FIG. 14 is a flowchart showing operations of a clear switch process according to the second embodiment;

FIG. 15 is a diagram showing a song data configuration according to a third embodiment;

FIG. 16 is a flowchart showing operations of a switch process according to the third embodiment;

FIG. 17 is a flowchart showing operations of a start/stop switch process according to the third embodiment;

FIG. 18 is a flowchart showing operations of a pedal switch process according to the third embodiment;

FIG. 19 is a flowchart showing operations of a guide process according to the third embodiment;

FIG. 20 is a flowchart showing operations of the guide process according to the third embodiment; and

FIG. 21 is a flowchart showing operations of a key-pressing process according to the third embodiment.

### DETAILED DESCRIPTION OF THE PREFERRED EMBODIMENTS

The present invention will hereinafter be described in detail with reference to the preferred embodiments shown in the accompanying drawings.

### A. First Embodiment

A-1. Configuration

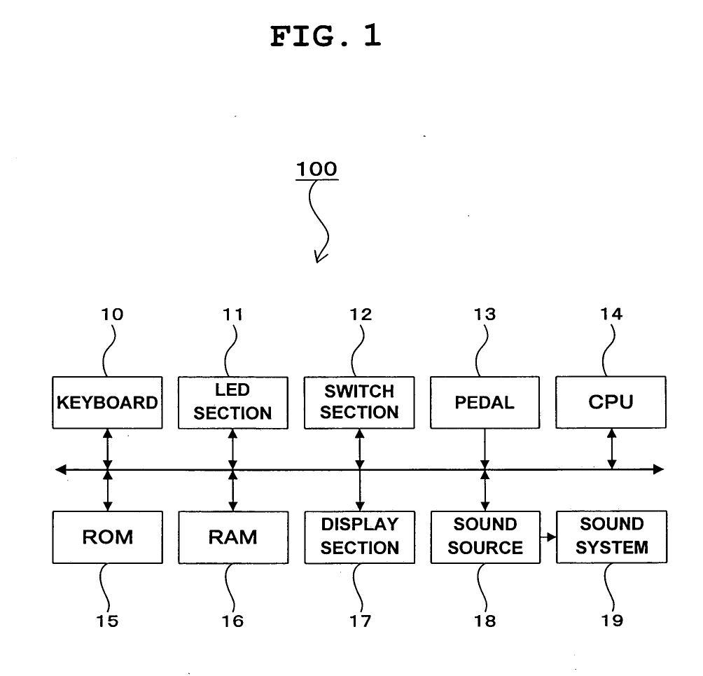

FIG. 1 is a block diagram showing a configuration of a musical performance training device 100 according to a first embodiment of the present invention. In the diagram, a keyboard 10 generates performance information, such as a key-ON/key-OFF event, a key number, velocity, and the like, depending on the pressing and releasing of the keys (performance operation). An LED section 11 includes LED and a driver (not shown). The LED is mounted on each key on the keyboard 10. The driver illuminates and drives the LED. The LED section 11 guides a user to the key to be played by illuminating the LED of a designated key, in adherence to a control signal provided by a CPU 14.

A switch section 12 has various operation switches mounted on a device panel. The switch section 12 generates a switch event corresponding with the type of switch operated by the user. As the main switches mounted on the switch section 12, there is, for example, a start/stop switch SS, in addition to a power switch and a song selection switch. The start/stop switch SS instructs the start and the termination of the musical performance training. The power switch turns ON and turns OFF the power supply of the device. The song selection switch selects the song data used in the musical performance training. Details of the processing operations corresponding to the operation of the start/stop switch SS will be described hereafter. A pedal 13 generates an ON-event or an OFF-event depending on user operation. The processing operations corresponding to the ON/OFF events generated by the pedal 13 will be described in detail in the third embodiment.

When the start of the musical performance training is instructed by the start/stop switch SS being turned ON, the CPU 14 reads song data (described hereafter) stored in a RAM 16 and guides the user to a key to be played. In addition, depending on the pressing and releasing of the keys performed by the user in adherence to the guidance, the CPU 14 generates various musical tone parameters (such as note-ON/note-OFF) corresponding to the performance information outputted from the keyboard 10. The CPU 14 provides the musical tone parameters to a sound source 18. A ROM 15 includes a program area and a data area. Various control programs to be loaded into the CPU 14 are stored in the program area of the ROM 15. The various control programs include a main routine, a switch process, a guide process, and a key-pressing process, described hereafter. The data area of the ROM 15 stores song data of a plurality of songs used in the musical performance training. The song data selected from among the stored song data by a song selection switch operation is copied to a data area of the RAM 16.

The RAM 16 includes a work area and a song data area. The work area of the RAM 16 temporarily stores various register and flag data used in processes performed by the CPU 14. The song data area of the RAM 16 stores the song data copied from the ROM 15 by the song selection switch operation.

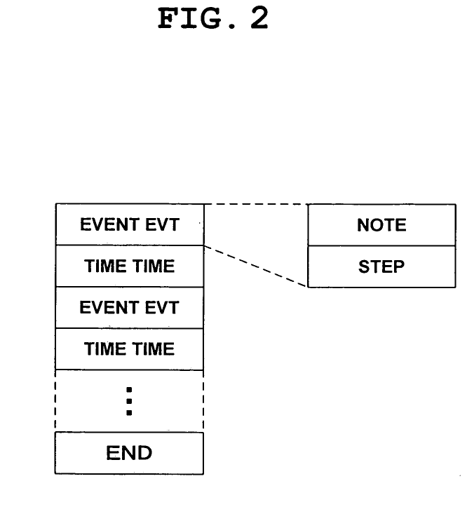

FIG. 2 is a diagram showing a configuration of the song data stored in the song data area of the RAM 16. The song data indicating each sound composing the song is formed in a data format that is a so-called relative time format. Event EVT and time TIME of the song data form a pair and are stored in the order of address by time sequence corresponding to the song progression. End data END indicating the end of the song is provided at the end of the song data.

The event EVT includes a note and a step. The note designates the pitch to be sounded (key number) and the step indicates the training mode of the sound of the pitch designated by the note. In the present embodiment, the value of the step is defined as “0” or “1”. As described hereafter, the value of the step set to “0” indicates that the sound is in self-running mode. The value of the step set to “1” indicates that the sound is in wait mode.

Here, the self-running mode refers to a training mode in which the reading of the song data is continued regardless of whether the key to which the user is guided by the illumination of the LED is pressed. On the other hands, the wait mode refers to a training mode in which the song progression is temporarily stopped at the sounding timing of the key to which the user is guided the illumination of the LED, subsequently, the song data of the next sound is read and the song is continued when the key to which the user is guided is correctly pressed.

The time TIME indicates the corresponding sounding timing of the event EVT by the time elapsed from the previous event EVT. The time TIME at the head of the song data specifies the sounding timing of the first event EVT by the time elapsed from the start of the song.

A display section 17 includes a liquid crystal display (LCD) panel or the like. The display section 17 displays the operation mode and the various setting states of the overall device according to a display control signal provided by the CPU 14. The sound source 18 is configured by a widely known waveform memory reading method and includes a plurality of sounding channels that operate by time-division. The sound source 18 stores waveform data of various tones. The sound source 18 reads the waveform data according to the musical tone parameters provided by the CPU 14 from among the stored waveform data and generates a musical tone waveform. A sound system 19 converts the musical tone waveform outputted from the sound source 18 to an analog-format musical tone signal. The sound system 19 performs filtering, such as to remove unnecessary noise from the musical tone signal, amplifies the level, and produces the sound from a speaker.

A-2. Operations

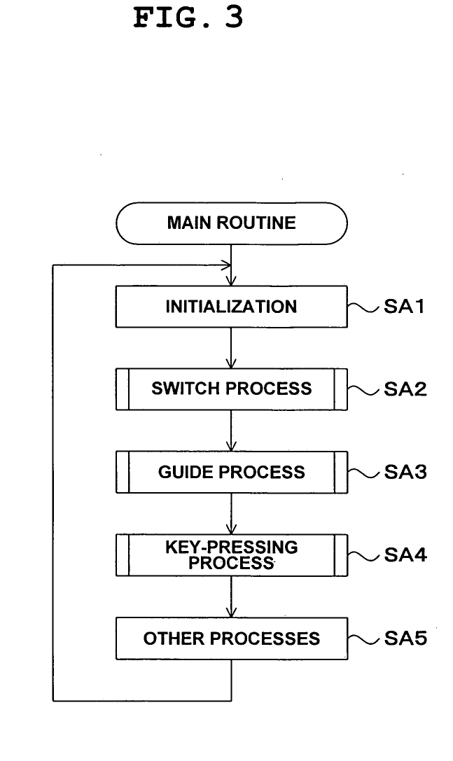

Next, operations according to the first embodiment will be described with reference to FIG. 3 to FIG. 10. Here, operations of the main routine are described first. Subsequently, respective operations of the switch process, the guide process, and the key-pressing process included in the main routine will be described.

(a) Operations of the Main Routine

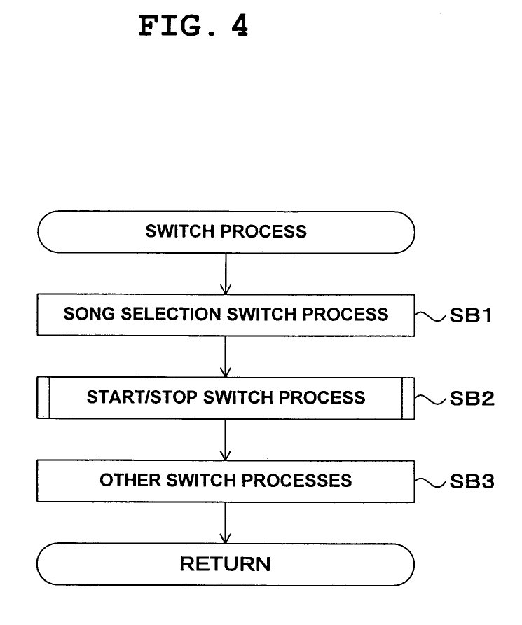

When the musical performance training device 100 according to the above-described configuration is turned ON, the CPU 14 performs the main routine shown in FIG. 4. The CPU 14 advances the process to Step SA1 and performs initialization, such as resetting the various register and flag data stored in the work area of the RAM 16 to zero and setting initial values. Next, at Step SA2, the CPU 14 performs the switch process. In the switch process, for example, the CPU 14 transfers the song data selected according to a song selection switch operation to the song data area of the RAM 16 and instructs the start or the termination of the musical performance training depending on the start/stop switch SS operation. The song data is selected from among the song data of the plurality of songs stored in the ROM 15.

Next, at Step SA3, the CPU 14 performs the guide process. In the guide process, the CPU 14 reads the song data indicating each sound composing the song from the song data area of the RAM 16 and guides the user to the key to be played. In the guide process, as described hereafter, if the read sound is in self-running mode, the CPU 14 reads the song data of the next sound at the sounding timing of the previous sound and guides the user to the key to be played. However, when the read sound is in wait mode, the CPU 14 temporarily stops the operation for guiding the user to the key to be played at the sounding timing of the previous sound.

Next, at Step SA4, the CPU 14 performs the key-pressing process. In the key-pressing process, when the training mode of the sound to which the user is currently being guided is self-running mode, the CPU 14 instructs the sounding of the key that is pressed or released, regardless of the key to which the user has been guided. When the sound is in wait mode, the CPU 14 continues reading the next song data only when the key to which the user has been guided is correctly pressed. Next, at Step SA5, the CPU 14 performs other processes, such as transcribing the song data stored in the song data area of the RAM 16 into a musical score and displaying the musical score in the display section 17, and displaying the training mode on the musical note of the sound to which the user is currently being guided in the displayed musical score and notifying the user. Then, the CPU 14 returns the process to Step SA1. Subsequently, the CPU 14 repeats Steps SA1 to SA5 until the device is turned OFF.

(b) Operations of the Switch Process

Next, operations of the switch process will be described with reference to FIG. 4. When the present process is performed via the above-described Step SA2 of the main routine (see FIG. 3), the CPU 14 advances the process to Step SB1 shown in FIG. 4. At Step SB1, the CPU 14 performs a song selection switch process. In the song selection switch process, the CPU 14 copies the song data selected from among the song data of the plurality of songs stored in the ROM 15 to the song data area of the RAM 16, according to the operation of the song selection switch. Next, at Step SB2, the CPU 14 performs a start/stop switch process. In the start/stop switch process, the CPU 14 instructs the start or the termination of the training according to the operation of the start/stop switch SS. Then, the CPU 14 proceeds to Step SB3, performs processes corresponding to other switch operations, and completes the present process.

(c) Operations of the Start/Stop Switch Process

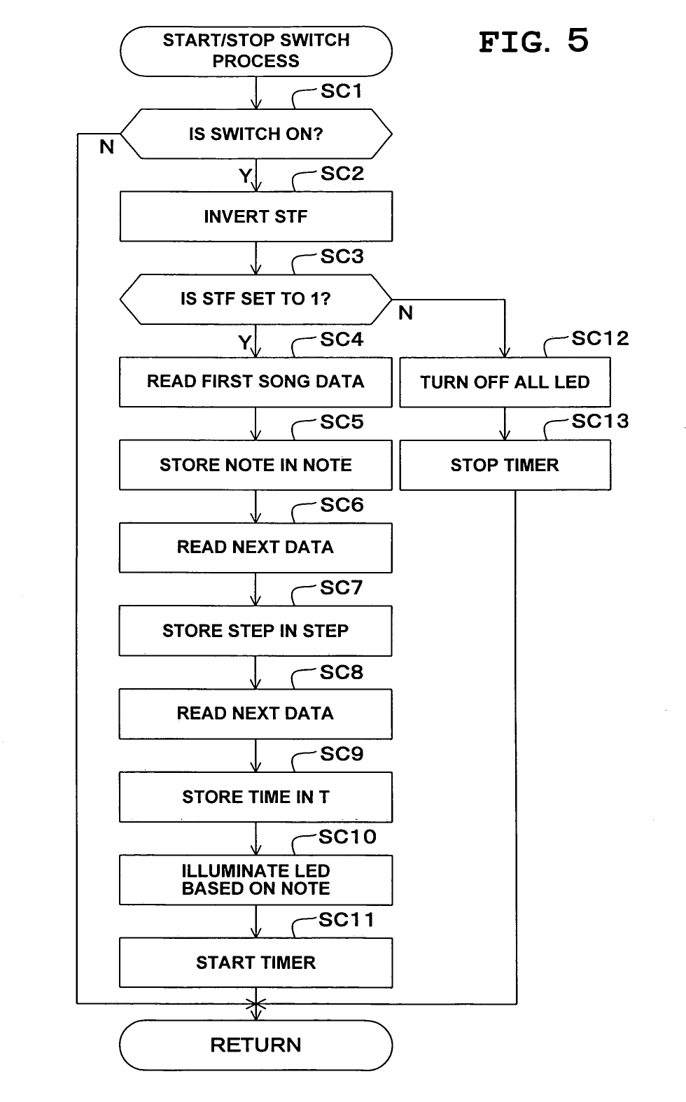

Next, operation of the start/stop switch process will be described with reference to FIG. 5. When the present process is performed via the above-described Step SB2 of the switch process (see FIG. 4), the CPU 14 proceeds to Step SC1 shown in FIG. 5. At Step SC1, the CPU 14 judges whether an ON-operation of the start/stop SS switch is performed. When the ON-operation of the start/stop SS switch is not performed, the judgment result is “NO”. The CPU 14 completes the process without performing any operations. However, when the ON-operation is performed, the judgment result is “YES”, and the CPU 14 advances the process to Step SC2.

At SC2, the CPU 14 inverts a start flag STF. When the start flag STF is set to “1”, a start state that instructs the start of the training is indicated. When the start flag STF is set to “0”, a stop state that instructs the termination of the training is indicated. In other words, the start/stop switch SS is configured by a so-called toggle switch that alternately instructs “start training” and “stop training” every time an ON-operation of the start/stop switch SS is performed. Therefore, the CPU 14 inverts the start flag STF every time the ON-operation of the start/stop switch SS is performed.

At Step SC3, the CPU 14 judges whether the inverted start flag STF is “1” or, in other words, set to the start state. When the start flag STF is set to the start state, the judgment result is “YES”, and the CPU 14 performs Steps SC4 to SC11, described hereafter. At the same time, when the start flag STF is set to the stop state, the judgment result is “NO”, and the CPU 14 performs Steps SC12 to SC13, described hereafter. Hereafter, the operations in the start state and the operations in the stop state will be separately described.

<Operations in the Start State>

When the start flag STF is set to the start state, the judgment result at Step SC3 is “YES”. The CPU 14 proceeds to Step SC4 and reads the first data of the song data stored in the song data area of the RAM 16 (see FIG. 2). In other words, the CPU 14 reads the note within the first event EVT. Next, at Step SC5, the CPU 14 stores the read note in register NOTE. At Step SC6, after reading the note, the CPU 14 reads the step within the first event EVT. At Step SC7, the CPU 14 stores the read step in register STEP. Then, at Step SC8, the CPU 14 reads the time TIME, which is the next data. At Step SC9, the CPU 14 stores the read time TIME in register T.

After completing the reading of the event EVT and time TIME at the head of the song data in this way, the CPU 14 proceeds to Step SC10. At Step SC10, CPU 14 instructs the LED section 11 to illuminate the LED mounted on the key designated by the note (key number) stored in register NOTE. As a result, the user is guided to the first key to be played. Next, at Step SC11, the CPU 14 starts a timer for timing the sounding timing of the event EVT and completes the present process. When the timer is started at Step SC11, the CPU 14 performs a timer interrupt process (not shown) that counts the timer clock at a constant frequency and keeps time.

<Operations in the Stop State>

When the start flag STF is set to the stop state, the judgment result at Step SC3 is “NO”. The CPU 14 proceeds to Step SC12 and instructs the LED section 11 to turn off all LED mounted on each key on the keyboard 10. Then, the CPU 14 proceeds to Step SC13, stops the timer (timer interrupt process termination), and completes the present process.

In this way, in the start/stop switch process, when the start flag STF is set to the start state, the LED mounted on the key to be played first is illuminated, based on the first event EVT within the song data stored in the song data area of the RAM 16, and the user is guided to the key to be played. In addition, the timer timing the sounding timing of the event EVT is started. At the same time, when the start flag STF is set to the stop state, all LED mounted on each key are turned off and the timer is stopped.

(d) Operations of the Guide Process

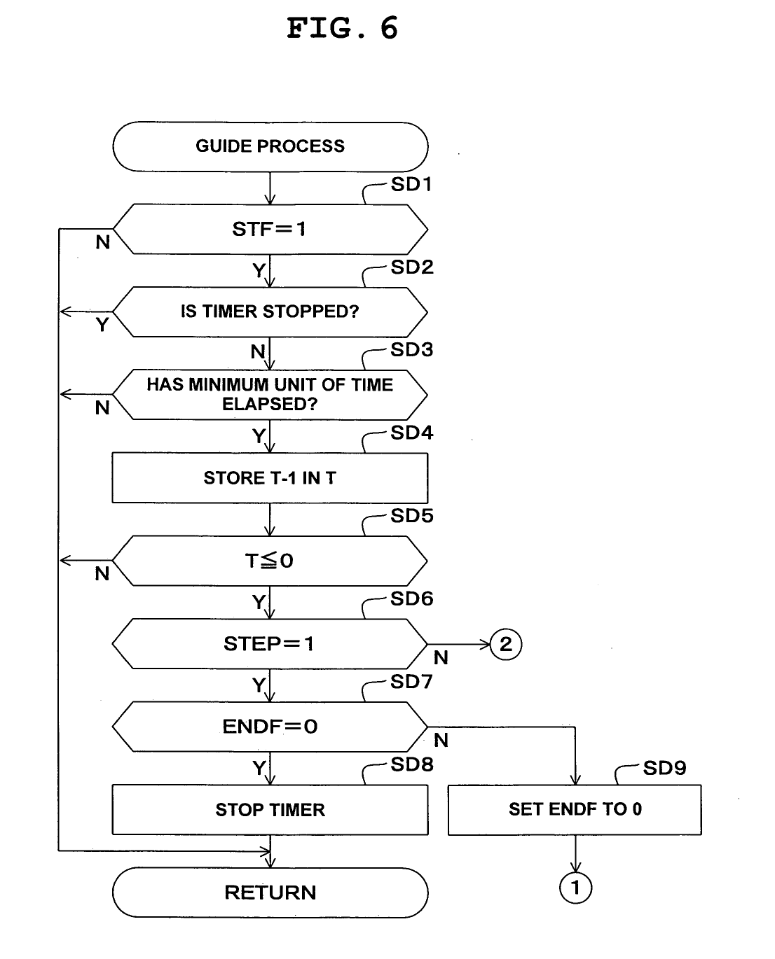

Next, the operations of the guide process will be described with reference to FIG. 6 to FIG. 8. When the present process is performed via the above-described Step SA3 (see FIG. 3) of the main routine, the CPU 14 proceeds to Step SD1 shown in FIG. 6. At Step SD1, the CPU 14 judges whether the start flag STF is “1” or, in other words, set to the start state. When the start flag STF is set to the stop state, the judgment result is “NO”. The CPU 14 completes the process without performing any operations. When the start flag STF is set to the start state, the judgment result is “YES”, and the CPU 14 proceeds to Step SD2. At Step SD2, the CPU 14 judges whether the timer is stopped. When the timer is stopped, the judgment result is “YES”, and the CPU 14 completes the present process. When the timer is running, the judgment result is “NO”, and the CPU 14 proceeds to Step SD3.

At Step SD3, the CUP 14 judges whether a minimum unit of time has elapsed. The minimum unit of time depends on the tempo value of the song being used for the musical performance training. When the minimum unit of time has not elapsed, the judgment result is “NO” and the CPU 14 temporarily completes the present process. At the same time, when the minimum unit of time has elapsed, the judgment result is “YES”, and the CUP 14 proceeds to the following Step SD4. At Step SD4, the CPU 14 decrements the value in register T (time TIME). Then, at Step SD5, the CUP 14 judges whether the decremented value in register T is “0” or below. In other words, the CPU 14 judges whether the sounding timing of the event EVT of which guidance is currently being performed is reached. When the sounding timing is not reached, the judgment result is “NO”, and the CPU 14 completes the present process.

On the other hand, when the sounding timing of the event EVT is reached, the judgment result at Step SD5 is “YES”, and the CPU 14 proceeds to Step SD6. At Step SD6, the CPU 14 judges whether the value of the step stored in register STEP is “1”. In other words, the CPU 14 judges whether the training mode of the sound to which the user is currently being guided is wait mode. Hereafter, the operations when the sound is in “self-running” mode and the operations when the sound is in “wait mode” will be separately described.

<In Self-Running Mode>

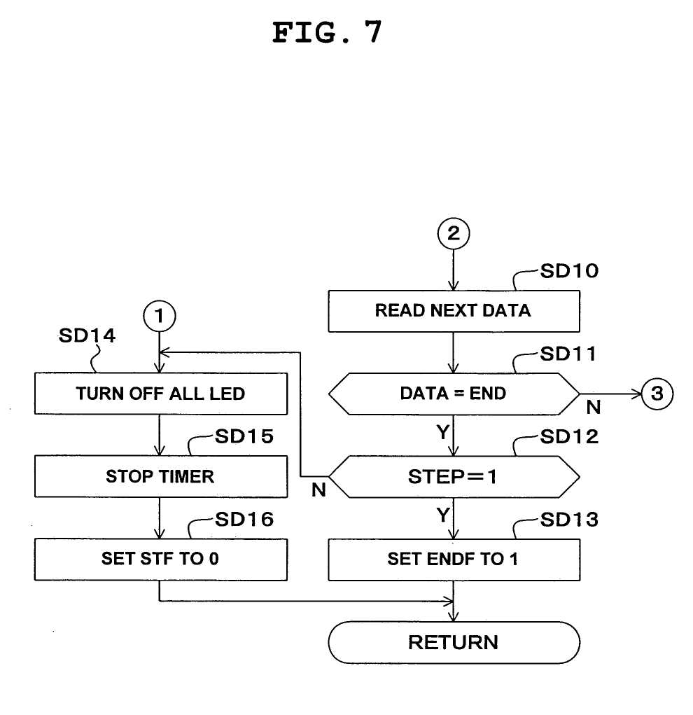

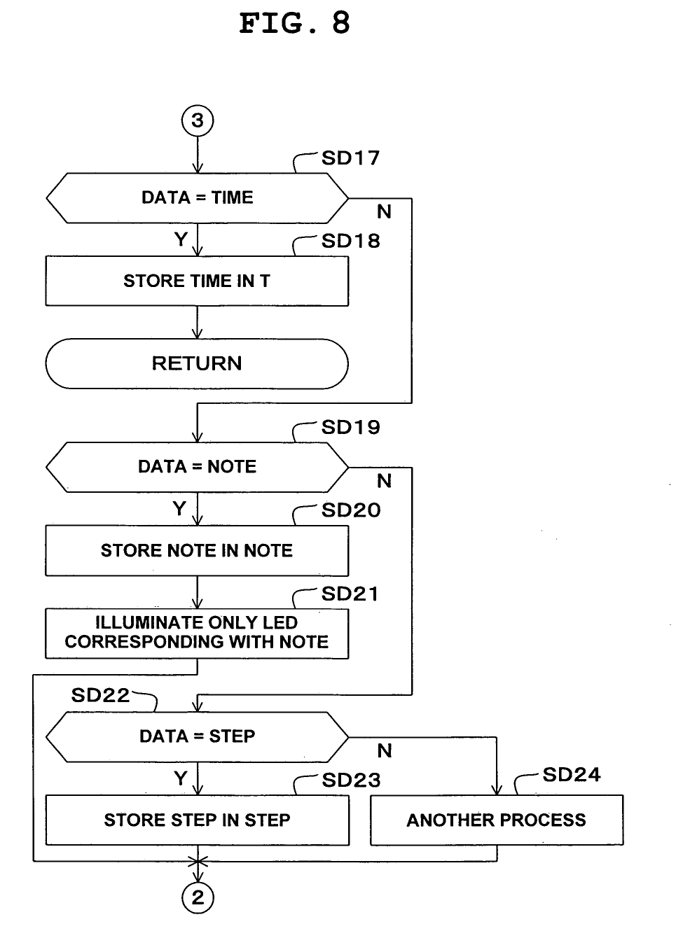

When the training mode of the sound to which the user is currently being guided is self-running mode, the judgment result at Step SD6 is “NO”, and the CPU 14 proceeds to Step SD10 shown in FIG. 7. At Step SD10, the CPU 14 reads the next data from the song data area of the RAM 16. Next, at Step SD11, the CPU 14 judges whether the read data is the end data END indicating the end of the song. When the read data is not the end data END, the judgment result is “NO”, and the CPU 14 proceeds to Step SD17 shown in FIG. 8. In the steps subsequent to Step SD17, the processes corresponding to data types read out in sequence from note, step, to time TIME are performed.

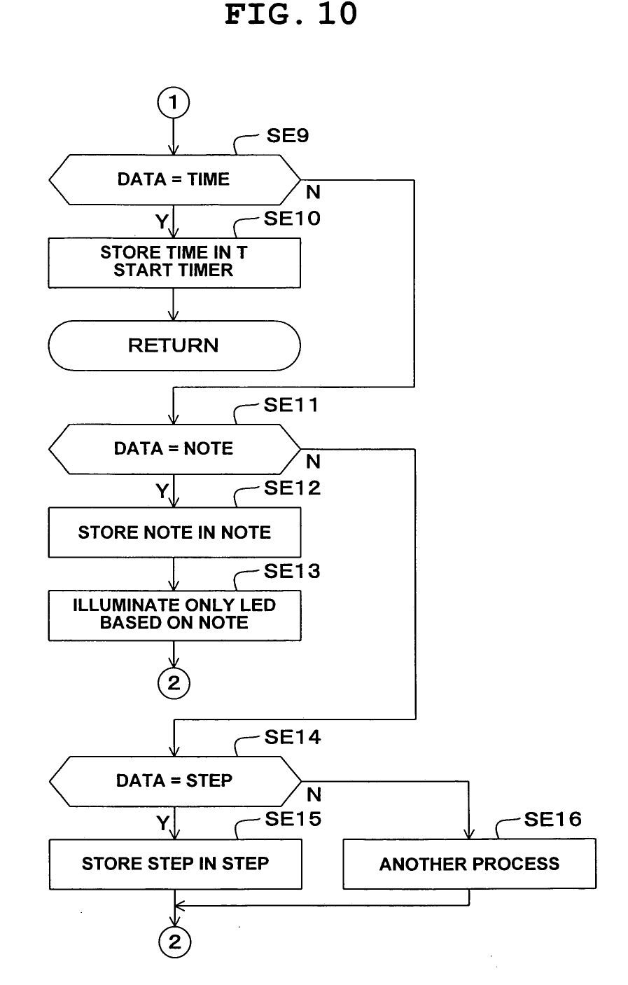

More specifically, when the note in the event EVT is read, the judgment result at Step SD19 is “YES”. The CPU 14 proceeds to Step SD20 and stores the note in register NOTE. At the subsequent Step SD21, the CPU 14 instructs the LED section 11 to illuminate only the LED mounted to the key designated by the note (key number) stored in register NOTE. Then, the CPU 14 returns the process to Step SD10 shown in FIG. 10 and reads the next data.

Next, when the step in the event EVT is read, the judgment result at Step SD22 is “YES”. The CPU 14 proceeds to Step SD23 and stores the step in register STEP. Then, the CPU 14 returns the process to Step SD10 (see FIG. 7) and reads the next data. Next, when the time TIME is read, the judgment result at Step SD17 is “YES”. The CPU 14 proceeds to Step SD18, stores the time TIME in register T and temporarily completes the present process.

When data other than the note, step, and time TIME is read, for example, when an event data instructing a change in the musical tone is read, the respective judgment results at Steps SD17, SD19, and SD22 are “NO”. The CPU 14 proceeds to Step SD24 and performs “another process” that instructs the sound source 18 to change the musical tone according to the event. Then, the CPU 14 returns the process to Step SD1O (see FIG. 7) and reads the next data.

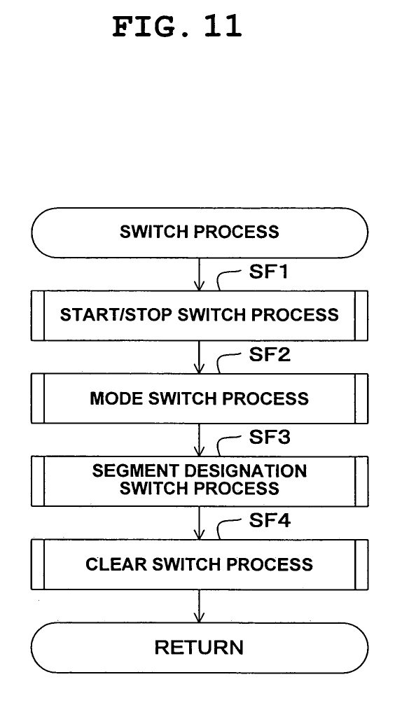

As described above, when, for example, sounds in self-running mode are consecutively read, the CPU 14 reads the song data of the next sound (note, step, and time) every time the sounding timing of the previous sound is reached. The CPU 14 successively guides the user to the keys to be played by illuminating only the LED of the keys designated by the read notes. Then, when the send data END is read, the judgment result at Step SD11 (see FIG. 11) is “YES”. The CPU 14 proceeds to SD12 and judges whether the value of the step stored in register STEP is “1”. In other words, the CPU 14 judges whether the sound before the end of the song is in wait mode.

When the sound before the end of the song is in self-running mode, the judgment result is “NO”. The CPU 14 proceeds to Step SD14 and instructs the LED section 11 to turn off all LED mounted on each key on the keyboard 10. Then, the CPU 14 stops the timer at Step SD15, and proceeds to Step SD16. At Step SD16, the CPU 14 sets the start flag STF to “0” to set the start flag STF to the stop state and completes the present process. On the other hand, when the song before the end of the song is in wait mode, the judgment result at Step SD12 is “YES”. The CPU 14 proceeds to Step SD13, sets an end flag ENDF to “1”, and completes the present process.

<In Wait Mode>

When the training mode of the sound to which the user is currently being guided is wait mode, the judgment result at Step SD6 (see FIG. 6) is “YES”. The CPU 14 proceeds to Step SD7 and judges whether the end flag ENDF is “0”. In other words, the CPU 14 judges whether the end of the song is not reached. When the end of the song is not reached, the judgment result is “YES”, and the CPU 14 proceeds to Step SD8. At Step SD8, the CPU 14 stops the timer (terminates the timer interrupt process) and completes the present process. Therefore, when the end of the song has not been reached and the sound is in wait mode, the guide operation for guiding the user to the key to be played at the sounding timing is temporarily terminated. As described hereafter in the key-pressing process, the temporarily terminated guide operation is restarted upon the key to which the user is guided being properly pressed.

At the same time, when the end of the song is reached or, in other words, when the sound before the end of the song is in wait mode, the CPU 14 sets the end flag ENDF to “1” at Step SD13 (see FIG. 7). Therefore, the judgment result at Step SD7 is “NO”. The CPU 14 proceeds to Step SD9 and resets the end flag ENDF to zero. Then, at Step SD14 shown in FIG. 7, the CPU 14 instructs the LED section 11 to turn off all LED mounted on each key on the keyboard 10. At the subsequent Step SD15, the CPU 14 stops the timer. Then, the CPU 14 proceeds to Step SD16, sets the start flag STF to “0” to set the start flag STF to the stop state and completes the present process.

In this way, in the guide process, when the song data of the sound in self-running mode is read, the song data (note, step, and time) of the next sound is read at the sounding timing of the previous sound. Only the LED of the key designated by the read note is illuminated, and the user is guided to the key to be played. At the same time, when the song data of the sound in wait mode is read, the guide operation for guiding the user to the key to be played at the sounding timing of the previous sound is temporarily terminated.

(e) Operations of the Key-Pressing Process

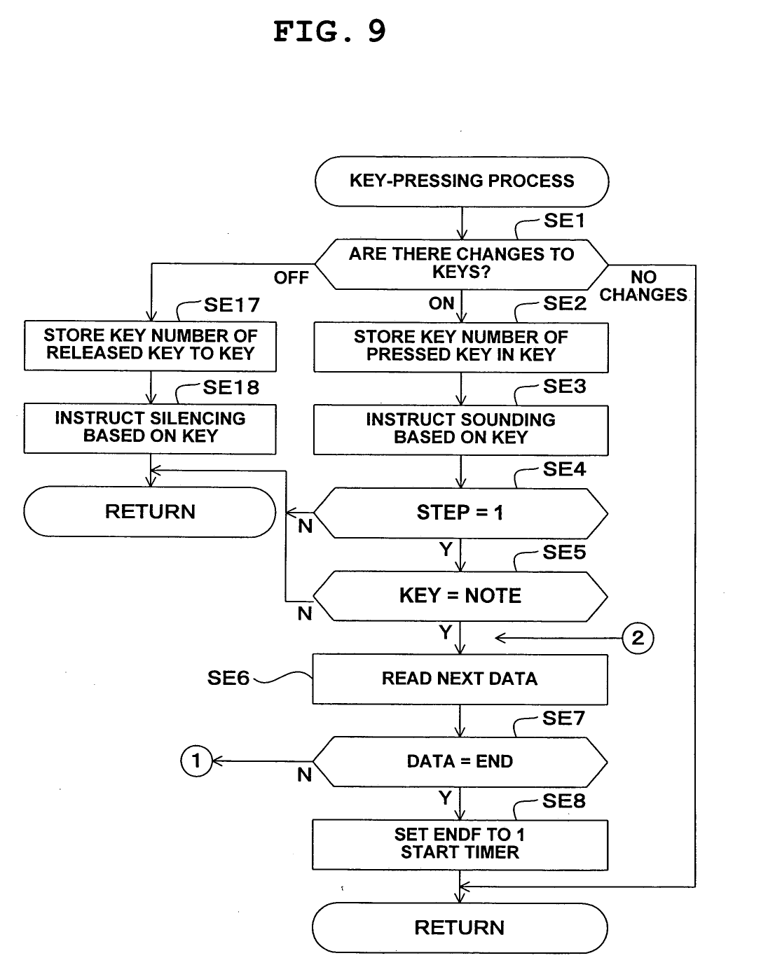

Next, the operations of the key-pressing process will be described with reference to FIG. 9 to FIG. 10. When the present process is performed via the above-described Step SA4 of the main routine (see FIG. 3), the CPU 14 proceeds to Step SE1 shown in FIG. 9. At Step SE1, the CPU 14 determines changes to the keys based on the result of a key scanning performed on the keyboard 10. When the user has not pressed or released a key and no changes to the keys are generated at Step SE1, the CPU 14 completes the present process without performing any operations. At the same time, when a key-ON event according to the pressing of a key is generated, the CPU 14 performs the steps subsequent to Step SE2. When a key-OFF event according to the release of a key is generated, the CPU 14 performs Steps SE17 to SE18. Hereafter, the operations when a key is pressed and the operations when a key is released are separately described.

<When Key is Pressed>

When a key-ON event according to the pressing of a key is generated, the CPU 14 proceeds to Step SE2. At Step SE2, the CPU 14 stores the key number of the key that is being pressed in register KEY. Next, at Step SE3, the CPU 14 instructs the sound source 18 to sound the musical tone of the pitch corresponding to the key number stored in register KEY. Next, at Step SE4, the CPU 14 judges whether the value of the step stored in register STEP is “1”. In other words, the CPU 14 judges. whether the training mode of the sound to which the user is currently being guided is wait mode. When the sound is in self-running mode, the judgment result is “NO”, and the CPU 14 completes the present process. In other words, in self-running mode, the CPU 14 only sounds the musical tone of the pitch designated by the pressed key and completes the present process. As a result, the training mode is that which the reading of the subsequent song data is successively continued, regardless of whether the key to which the user is guided as the key to be played in the afore-mentioned guide process (see FIG. 6 to FIG. 8) is pressed.

At the same time, when the sound is in wait mode, the judgment result at Step SE4 is “YES”. The CPU 14 proceeds to Step SE5 and judges whether the key number stored in register KEY and the note (key number) stored in register NOTE match. In other words, the CPU 14 judges whether the key to which the user is guided is pressed. When the key to which the user is guided is not pressed, the judgment result is “NO”, and the CPU 14 completes the present process. On the other hand, when the key to which the user is guided is pressed, the judgment result is “YES”. The CPU 14 proceeds to Step SE 6 and reads the next data from the song data area of the RAM 16.

Next, at Step SE7, the CPU 14 judges whether the read data is the end data END indicating the end of the song. When the read data is not the end data END, the judgment result is “NO”, and the CPU 14 proceeds to Step SE9 shown in FIG. 10. At Steps SE9 to SE16, the processes corresponding to the data types read out in sequence from note, step, to time TIME are performed.

More specifically, when the note within the event EVT is read, the judgment result at Step SE11 is “YES”. The CPU 14 proceeds to Step SE12 and stores the note in register NOTE. At the subsequent Step SE13, the CPU 14 instructs the LED section 11 to illuminate only the LED mounted on the key designated by the note (key number) stored in register NOTE. Then, the CPU 14 returns the process to Step SE6 (see FIG. 9) and reads the next data.

Next, when the step within the event EVT is read, the judgment result at Step SE14 is “YES”. The CPU 14 proceeds to Step SE15 and stores the step in register STEP. The CPU 14 returns the process to Step SE6 and reads the next data. When the time TIME is read, the judgment result at Step SE9 is “YES”, and the CPU 14 proceeds to Step SE10. At Step SE10, the CPU 14 stores the time TIME in register T, starts the timer, and completes the present process.

When data other than the note, step, and time TIME is read, for example, when an event data instructing a change in the musical tone is read, the respective judgment results at Step SE9, SE11, and SE14 are “NO”. The CPU 14 proceeds to Step SE16 and performs “another process” for instructing the sound source 18 to change the musical tone according to the event. Then, the CPU 14 returns the process to Step SE6 and reads the next data.

In this way, in wait mode, when the key to which the user is guided as the key to be played is pressed, the CPU 14 continues reading the song data. Then, when the read data is the end data END, the judgment result at Step SE7 (see FIG. 9) is “YES”, and the CPU 14 proceeds to Step SE8. At Step SE8, the CPU 14 sets the end flag ENDF to “1”, starts the timer, and completes the present process.

<When Key is Released>

When a key-OFF event according to the pressing of a key is generated, the CPU 14 proceeds to Step SE17 shown in FIG. 9. At Step SE17, the CPU 14 stores the key number of the key that is released in register KEY. Next, at Step SE18, the CPU 14 instructs the sound source 18 to silence the musical tone of the pitch corresponding to the key number stored in register KEY and completes the present process.

As described above, in the first embodiment, the CPU 14 reads song data indicating each sound composing the song and indicating the training mode (self-running mode or wait mode) of each sound. When the read sound is in self-running mode, the CPU 14 continues reading the song data regardless of whether the key to which the user is guided by the illumination of the LED is pressed. When the read sound is in wait mode, the CPU 14 temporarily stops the song progression at the sounding timing (key-pressing timing) of the key to which the user is guided by the illumination of the LED. Then, the CPU 14 reads the song data of the next sound when the key to which the user is guided is pressed. Therefore, for example, if sounds within a song requiring simple key manipulations are set to self-running mode and sounds requiring difficult key manipulations are set to wait mode, even a beginner who is not used to key manipulations can receive musical performance training. As a result, the training mode can be set for each sound composing the song and detailed musical performance training can be actualized.

In the present embodiment, to simplify the explanation, each sound has two types of training modes: self-running mode and wait mode. However, an embodiment that provides a “timing practice mode” in addition to the two types of training modes is possible. In the “timing practice mode”, the reading of the song data of the next song is advanced when the sounding timing of the key to which the user is guided (key-pressing timing) and the timing of the key manipulation match.

### B. Second Embodiment

Next, a second embodiment will be described with reference to FIG. 11 to FIG. 14. In the first embodiment, the value of the step is a fixed value. The step indicates the training mode of each sound and is included in the event EVT within the song data. On the other hand, in the second embodiment, the song data is displayed as a musical score. The value of the step of each sound included within a segment designated by the user can be changed on the displayed musical score. Hereafter, operations of a switch process implementing such a second embodiment will be described. The configuration according to the second embodiment differs from that of the first embodiment in that the configuration according to the second embodiment includes a mode switch, a segment designation switch, and a clear switch in the switch section 12. The purposes of the switches will be described hereafter.

(a) Operations of the Switch Process

The operations of the switch process according to the second embodiment will be described with reference to FIG. 11. As in the first embodiment, when the present process is performed via Step SA2 of the main routine (see FIG. 3), the CPU 14 performs a start/stop switch process via Step SF1 shown in FIG. 11. In the start/stop switch process, as in the first embodiment, when the start state is set according to the ON-operation of the start/stop switch, the CPU 14 illuminates the LED mounted on the key to be played first, based on the first event EVT, and guides the user to the key to be played. The first event EVT is included in the song data stored in the song data area of the RAM 16. In addition, the CPU 14 starts the timer that times the sounding timing of the event EVT. At the same time, when the stop state is set according to the ON-operation of the start/stop switch, the CPU 14 turns off all LED mounted on each key on the keyboard 10 and stops the timer.

Next, at Step SF2, the CPU 14 performs a mode switch process according to the ON-operation of the mode switch. In the mode switch process, the CPU 14 displays the song data stored in the song data area of the RAM 16 as a musical score in the display section 17 or deletes the musical score displayed in the display section 17. Then, at Step SF3, the CPU 14 performs a segment designation process according to the ON-operation of the segment designation switch. In the segment designation process, the CPU 14 sets the training mode of the song data respectively corresponding to each musical note included in the designated segment to wait mode, on the musical score displayed on a screen of the display section 17. Then, at Step SF4, the CPU 14 performs a clear switch process according to the ON-operation of the clear switch. In the clear switch process, the CPU 14 clears the steps included in all events EVT within the song data, sets the steps to zero, and sets the training mode of each sound to self-running mode. Then, the CPU 14 completes the present process.

(b) Operations of the Mode Switch Process

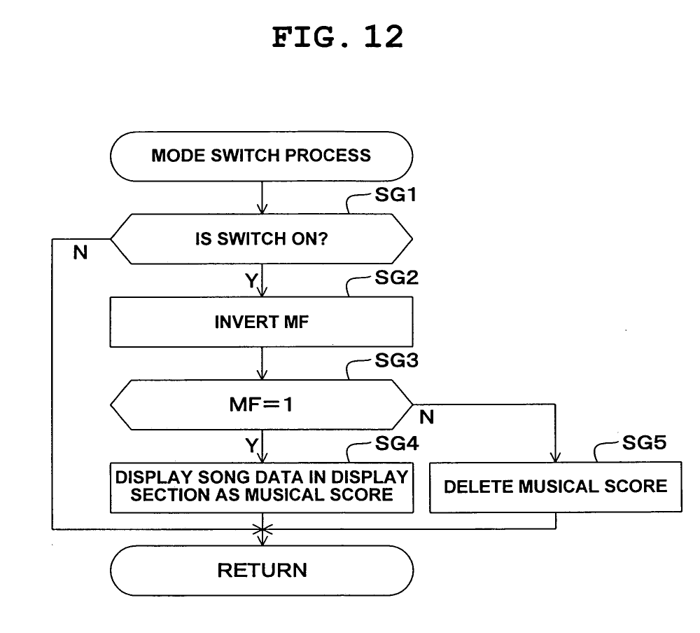

Next, operations of the mode switch process will be described with reference to FIG. 12. When the present process is performed via the above-described Step SF2 of the switch process (see FIG. 11), the CPU 14 proceeds to Step SG1 shown in FIG. 12. At Step SG1, the CPU 14 judges whether an ON-operation of the mode switch is performed. The mode switch gives instructions to display or not display the musical score of the song data stored in the song data area of the RAM 16. When the ON-operation of the mode switch is not performed, the judgment result at Step SG1 is “NO”. The CPU 14 completes the present process without performing any operations. When the ON-operation is performed, the judgment result is “YES”, and the CPU 14 proceeds to the subsequent Step SG2.

At Step SG2, the CPU 14 inverts a mode flag MF. Next, at Step SG3, the CPU 14 judges whether the inverted mode flag MF is “1”. When the inverted mode flag MF is “1”, the judgment result is “YES”. The CPU 14 proceeds to Step SG4 and transcribes the song data stored in the song data area of the RAM 16 into a musical score. The CPU 14 displays the musical score in the display section 17 based on the transcribed musical score. At the same time, when the inverted mode flag MF is “0”, the judgment result at Step SG3 is “NO”. The CPU 14 advances the process to Step SG5, deletes the musical score displayed in the display section 17, and completes the present process.

(c) Operations of the Segment Designation Process

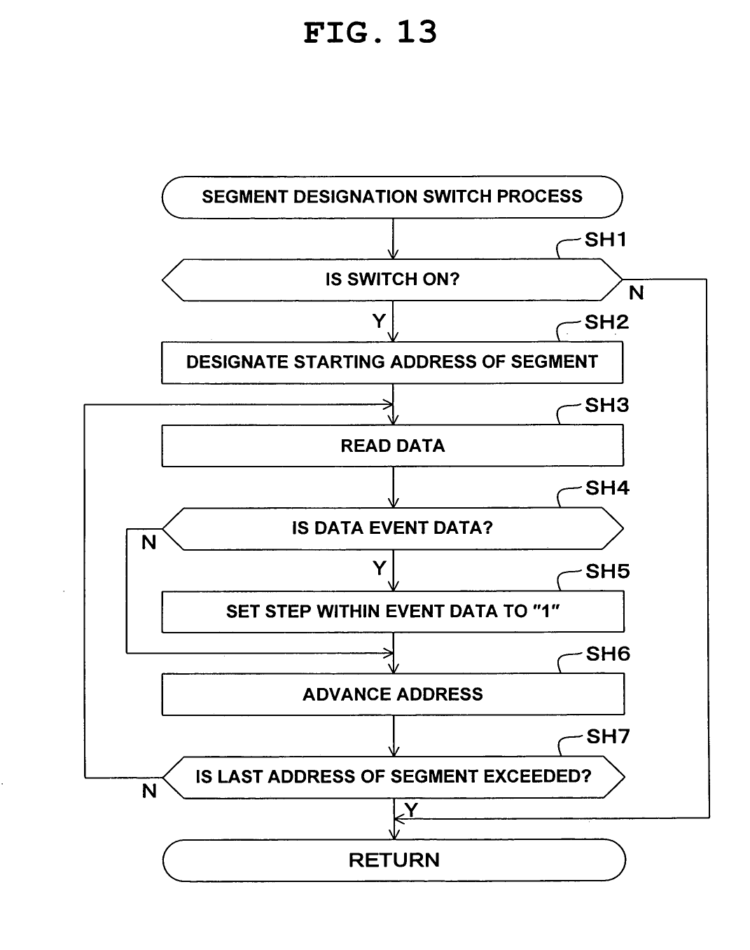

Operations of the segment designation process will be described with reference to FIG. 13. When the present process is performed via the above-described Step SF3 of the switch process (see FIG. 11), the CPU 14 proceeds to Step SH1 shown in FIG. 13. At Step SH1, the CPU 14 judges whether an ON-operation of the segment designation switch is performed. The segment designation switch finalizes a segment designating operation. The segment designating operation refers to an operation for designating the note at the start of a segment and the note at the end of the segment on the musical score displayed on the screen of the display section, using, for example, a pointing controller, such as a mouse. When the user performs an ON-operation of the segment designation switch after performing such a segment designating operation, the judgment result at Step SH1 is “YES”, and the CPU 14 proceeds to Step SH2.

At Step SH2, the CPU 14 specifies a starting address of the song data corresponding to the musical note at the start of the segment designated by the segment designating operation. Next, at Step SH3, the CPU 14 reads the song data corresponding to the specified starting address. Then, at Step SH4, the CPU 14 judges whether the read song data is the event EVT. When the read song data is the event EVT, the judgment result is “YES”. The CPU 14 proceeds to Step SH5 and sets the step within the event EVT to “1”. In other words, the CPU 14 sets the sound to wait mode and proceeds to the subsequent Step SH6.

At the same time, when the read song data is not the event EVT, the judgment result at Step SH4 is “NO”. The CPU 14 proceeds to Step SH6 and advances the address of the song data. At Step SH7, the CPU 14 judges whether the advanced address exceeds the last address corresponding to the musical note at the end of the segment designated by the segment designating operation. When the address does not exceed the last address, the judgment result is “NO”, and the CPU 14 returns the process to Step SH3. Subsequently, the CPU 14 repeats the Steps SH3 to SH7 until the last address is exceeded. In this way, the CPU 14 sets the steps of the song data respectively corresponding to the note at the start of the segment to the note at the end of the segment and sets the sounds to wait mode. Then, when the advanced address exceeds the last address, the judgment result at Step SH7 is “YES”, and the CPU 14 completes the present process.

(d) Operations of the Clear Switch Process

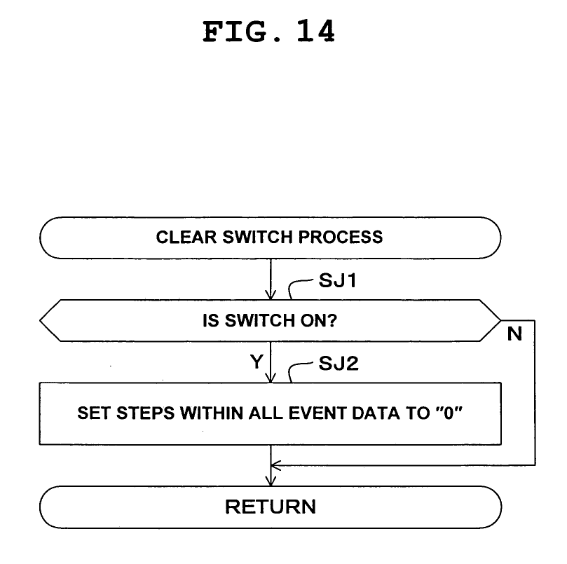

Next, operations of the clear switch process will be described with reference to FIG. 14. When the present process is performed via the above-described Step SF4 of the switch process (see FIG. 11), the CPU 14 proceeds to Step SJ1 shown in FIG. 14. At Step SJ1, the CPU 14 judges whether an ON-operation of the clear switch is performed. The clear switch clears the steps included in all events EVT within the song data and sets the steps to zero. When the ON-operation of the clear switch is not performed, the judgment result at Step SJ1 is “NO”. The CPU 14 completes the present process without performing any operations. When the ON-operation is performed, the judgment result is “YES”, and the CPU 14 proceeds to Step SJ2. At Step SJ2, the CPU 14 resets the value of the steps included in all events EVT within the song data stored in the song data area of the RAM 16 to an initial value of “0” (self-running mode) and completes the present process.

In this way, in the second embodiment, when the ON-operation of the mode switch is performed, the CPU 14 transcribes the song data stored in the song data area of the RAM 16 to a musical score and displays the musical score in the display section 17. When the ON-operation of the segment designation switch is performed after an operation for designating a segment in the musical score displayed on the screen has been performed, the CPU 14 sets the training modes of the song data respectively corresponding to each musical note included in the designated segment to wait mode. As a result, if, for example, a segment within the song requiring difficult key manipulation is designated, the training mode of the sounds in the segment can be set to wait mode. Therefore, even a beginner who is not used to key manipulation can receive musical performance training. As a result, the training mode can be set for each sound composing the song and detailed musical performance training can be given. In addition, when the ON-operation of the clear switch is performed, the training mode of each sound is reset to self-running mode. Therefore, the training mode of each sound can be set according to the user's wishes.

### C. Third Embodiment

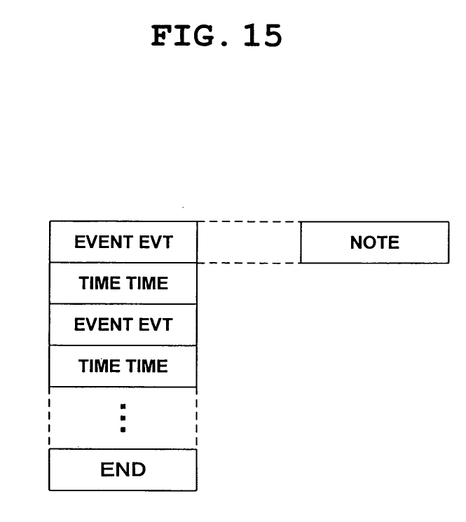

Next, a third embodiment will be described with reference to FIG. 15 to FIG. 21. In the above-described first embodiment, the step is provided in the event EVT included in the song data. The step indicates the training mode of each sound. On the other hand, in the third embodiment, the training mode of the sound to which the user is guided can be selected according to the ON/OFF state of the pedal 13 that is operated by the user. Hereafter, a configuration of song data implementing such a third embodiment will be described. Then, the respective operations of the switch process, the start/stop switch process, a pedal switch process, the guide process, and the key-pressing process, differing from those in the first embodiment, will be described.

C-1. Configuration of the Song Data

FIG. 15 is a diagram showing a configuration of the song data according to the third embodiment. As shown in the diagram, the event EVT and the time TIME in the song data stored in the song data area of the RAM 16 form a pair and are stored in the order of address by time sequence corresponding to the song progression. End data END indicating the end of the song is provided at the end of the song data. The song data shown in the diagram differs from that according to the first embodiment in that the event EVT includes only the note designating the sounded pitch (key number). In other words, the event EVT according to the first embodiment includes the step indicating the training mode of the sound of the pitch designated by the note. However, the step is omitted in the data configuration according to the third embodiment.

C-2. Operations

Next, the respective operations of the switch process, the start/stop switch process, the pedal switch process, the guide process, and the key-pressing process will be described.

(a) Operations of the Switch Process

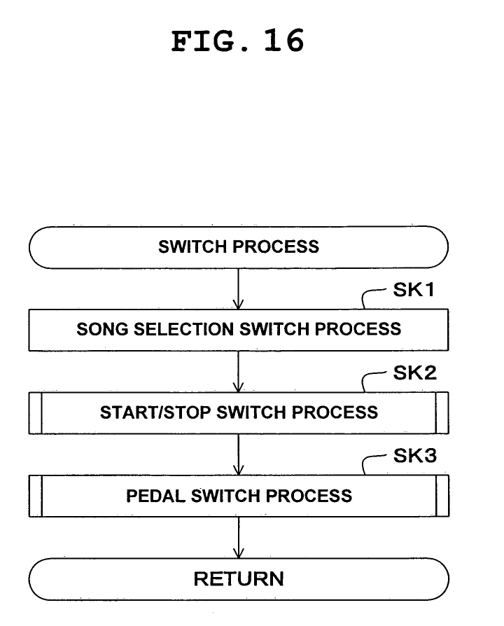

As in the first embodiment, when the present process is performed via Step SA2 (see FIG. 3) of the main routine, the CPU 14 advances the process to Step SK1 shown in FIG. 16 and performs a song selection switch process. In the song selection switch process, the CPU 14 copies the song data selected from among the song data of the plurality of songs stored in the ROM 15 to the song data area of the RAM 16, according to the operation of the song selection switch. Next, at Step SK2, the CPU 14 performs the start/stop switch process. In the start/stop switch process, the CPU 14 instructs the start or the termination of the training-according to the operation of the start/stop switch SS. Then, the CPU 14 proceeds to Step SK3 and performs the pedal switch process. In the pedal switch process, the CPU 14 selects the training mode (self-running mode or wait mode) of the sound to which the user is guided according to the ON/OFF state of the pedal 13 that is operated by the user. Then, the CPU 14 completes the present process.

(b) Operations of the Start/Stop Switch

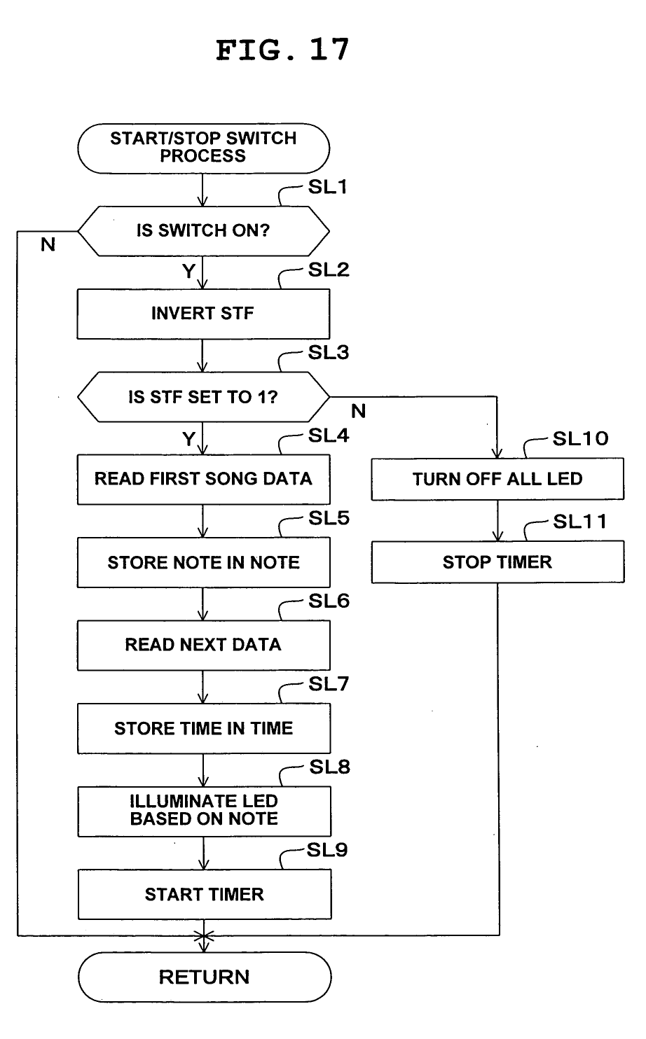

Next, the operations of the start/stop switch will be described with reference to FIG. 17. When the present process is performed via the above-mentioned Step SK2 of the switch process (see FIG. 16), the CPU 14 proceeds to Step SL1 shown in FIG. 17. At Step SL1, the CPU 14 judges whether the ON-operation of the start/stop switch SS is performed. When the ON-operation of the start/stop switch SS is not performed, the judgment result is “NO”. The CPU 14 completes the present process without performing any operations. On the other hand, when the ON-operation of the start/stop switch SS is performed, the judgment result at Step SL1 is “YES”, and the CPU 14 advances the process to Step SL2.

At Step SL2, the CPU 14 inverts the start flag STF. Next, at Step SL3, the CPU 14 judges whether the inverted start flag STF is “1” or, in other words, set to the start state. When the start flag STF is set to the start state, the judgment result is “YES”, and the CPU 14 performs Steps SL4 to SL9, described hereafter. At the same time, when the start flag STF is set to the stop state, the judgment result is “NO”, and the CPU 14 performs Steps SL10 to SL11, described hereafter. Hereafter, the operations when the start flag STF is set to the start state and the operations when the start flag STF is set to the stop state will be separately described.

<Operations in the Start State>

When the start flag STF is set to the start state, the judgment result at Step SL3 is “YES”, and the CPU 14 proceeds to SL4. At Step SL4, the CPU 14 reads the first data of the song data stored in the song data area of the RAM 16 (see FIG. 15). In other words, the CPU 14 reads the note within the first event EVT. Then, at Step SL5, the CPU 14 stores the read note in register NOTE. Next, at Step SL6, the CPU 14 reads time TIME, which is the next data. At the subsequent Step SL7, the CPU 14 stores the read time TIME in register T.

In this way, after completing the reading of the event EVT and the time TIME at the head of the song data, the CPU 14 proceeds to Step SL8. At Step SL8, the CPU 14 instructs the LED section 11 to illuminate the LED mounted on the key designated by the note (key number) stored in register NOTE. As a result, the user is guided to the key to be played first. Next, at Step SL9, the CPU 14 starts the timer for timing the sounding timing of the event EVT and completes the present process. When the timer is started at Step SC11, the CPU 14 performs the timer interrupt process (not shown) that counts the timer clock at a constant frequency and keeps time.

<Operations in the Stop State>

When the start flag STF is set to the stop state, the judgment result at Step SL3 is “NO”. The CPU proceeds to Step SL10 and instructs the LED section 11 to turn off all LED mounted on each key on the keyboard 10. Then, the CPU 14 proceeds to Step SL11. At Step SL11, the CPU 14 stops the timer (timer interrupt process termination) and completes the present process.

(c) Operations of the Pedal Switch Process

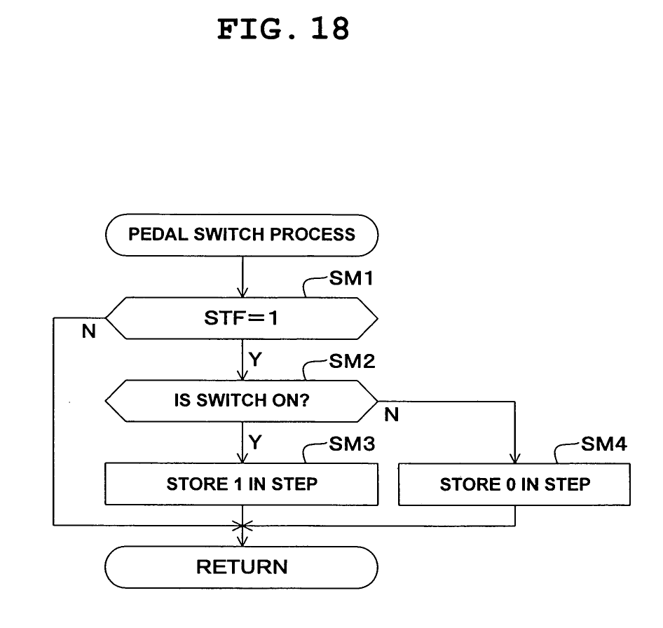

Next, the operations of the pedal switch process will be described with reference to FIG. 18. When the present process is performed via the afore-described Step SK3 of the switch process (see FIG. 16), the CPU 14 proceeds to Step SM1 shown in FIG. 18. At Step SM1, the CPU 14 judges whether the start flag STF is set to “1”, in other words, set to the start state. When the start flag STF is set to the stop state, the judgment result is “NO”. The CPU 14 completes the present process without performing any operations. At the same time, when the start flag STF is set to the start state, the CPU 14 proceeds to Step SM2. At Step SM2, the CPU 14 judges whether a pedal switch provided on the pedal 13 is set to ON. In other words, the CPU 14 determines the ON/OFF state of the pedal 13. When the pedal 13 is in the ON state, the judgment result is “YES”, and the CPU 14 proceeds to Step SM3. At Step SM3, the CPU 14 stores the value “1” indicating the wait mode in register STEP and completes the present process. Register STEP holds the value of the step that indicates the training mode. On the other hand, when the pedal 13 is in the OFF state, the judgment at Step SM2 is “NO”, and the CPU 14 proceeds to Step SM4. At Step SM4, the CPU 14 stores the value “0” indicating the self-running mode in register STEP, and completes the present process.

(d) Operations of the Guide Process

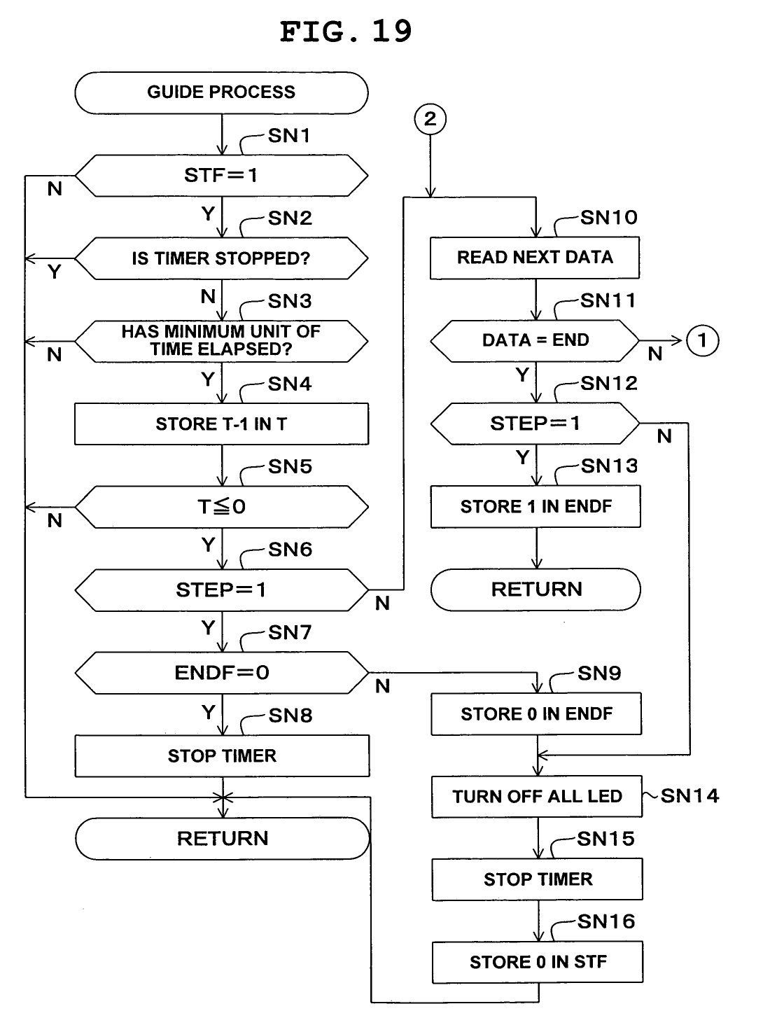

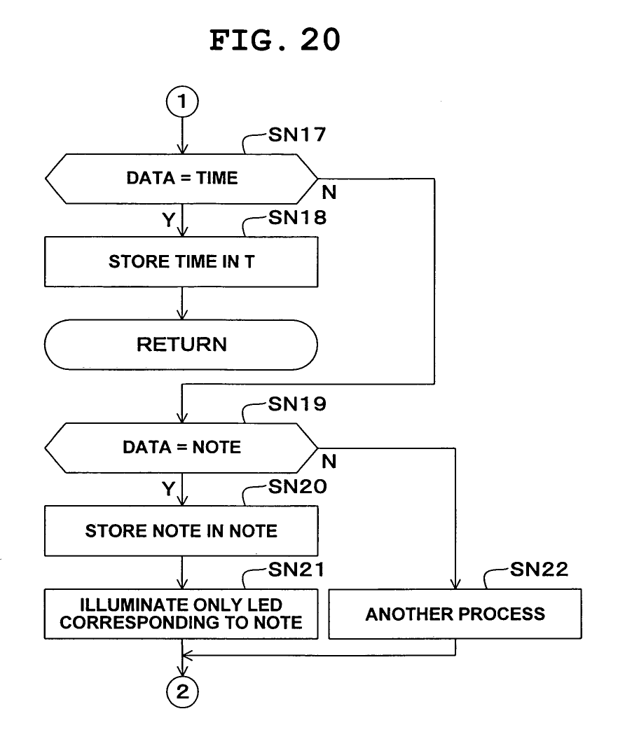

Next, the operations of the guide process will be described with reference to FIG. 19 to FIG. 20. As in the first embodiment, when the present process is performed via Step SA3 of the main routine, the CPU 14 proceeds to Step SN1 shown in FIG. 19. At Step SN1, the CPU 14 judges whether the start flag STF is set to “1” or, in other words, set to the start state. When the start flag STF is set to the stop state, the judgment result is “NO”. The CPU 14 completes the process without performing any operations. When the start flag STF is set to the start state, the judgment result is “YES”. The CPU 14 proceeds to Step SN2 and judges whether the timer is stopped. When the timer is stopped, the judgment result is “YES”, and the CPU 14 completes the present process. When the timer is running, the judgment result is “NO”, and the CPU 14 proceeds to Step SN3.

At Step SN3, the CPU 14 judges whether the minimum unit of time according to the tempo value of the song to be used in the musical performance training has elapsed. When the minimum unit of time has not elapsed, the judgment result is “NO”. The CPU temporarily completes the process. At the same time, when the minimum unit of time has elapsed, the judgment result is “YES”, and the CPU 14 proceeds to the subsequent Step SN4. At Step SN4, the CPU 14 decrements the value of register T (time TIME). Then, at Step SN5, the CPU 14 judges whether the decremented value in register T is “0” or below. In other words, the CPU 14 judges whether the sounding timing of the event EVT of which guidance is currently being performed is reached. When the sounding timing is not reached, the judgment result is “NO”, and the CPU 14 completes the present process.

On the other hand, when the sounding timing of the event EVT is reached, the judgment result at Step SN5 is “YES”, and the CPU 14 proceeds to Step SN6. At Step SN6, the CPU 14 judges whether the value of the step stored in register STEP is “1”, according to the ON/OFF state of the pedal 13. In other words, the CPU 14 judges whether the training mode of the sound to which the user is currently being guided is wait mode. Hereafter, the operations in “self-running mode” and the operations in “wait mode” will be separately described.

<When in Self-Running Mode>

When the training mode of the sound to which the user is currently being guided is set to self-running mode by the OFF-operation of the pedal 13, the judgment result at Step SN6 is “NO”. The CPU 14 proceeds to Step SN10 and reads the next data. Then, at Step SN11, the CPU 14 judges whether the read data is the end data END indicating the end of the song. When the read data is not the end data END, the judgment result is “NO”, and the CPU 14 proceeds to Step SN17 shown in FIG. 20. In the steps subsequent to Step SN17, the processes corresponding to the data types read in sequence from note to time TIME will be performed.

In other words, when the note within the event EVT is read, the judgment result at Step SN19 is “YES”. The CPU 14 proceeds to Step SN20 and stores the note in register NOTE. Next, at Step SN21, the CPU 14 instructs the LED section 11 to illuminate only the LED mounted on the key designated by the note (key number) stored in register NOTE. Then, the CPU 14 returns the process to Step SN10 shown in FIG. 19 and reads the next data. When the timer TIME is read, the judgment result at Step SN17 is “YES”, and the CPU 14 proceeds to Step SN18. At Step SN18, the CPU 14 stores the time TIME in register T and temporarily completes the present process.

When data other than the note is read from within the event EVT, for example, when event data instructing a change in the musical tone is read, the respective judgment results at Steps SN17 and SN19 are “NO”. The CPU 14 proceeds to Step SN22 and performs “another process” for instructing the sound source 18 to change the musical tone according to the event. Then, the CPU 14 returns the process to Step SD10 (see FIG. 19) and reads the next data.

As described above, when, for example, there are consecutive sounds set to self -running mode by the OFF-operation of the pedal 13, the CPU reads the song data (note and time) of the next sound every time the sounding timing of the previous sound is reached. The CPU 14 successively guides the user to the keys to be played by illuminating only the LED of the keys designated by the read notes. Then, when the end data END is read, the judgment result at Step SN11 shown in FIG. 19 is “YES”. The CPU 14 proceeds to Step SN12 and judges whether the value of the step stored in register STEP is “1”. In other words, the CPU 14 judges whether the sound before the end of the song is in wait mode.

When the sound before the end of the song is in self-running mode, the judgment result is “NO”. The CPU 14 proceeds to Step SN14 and instructs the LED section 11 to turn off all LED mounted on each key on the keyboard 10. Then, in the subsequent Step SN15, the CPU 14 stops the timer and proceeds to Step SN16. At Step SN16, the CPU 14 sets the start flag STF to “0” to set the start flag STF to the stop state and completes the present process. On the other hand, when the sound before the end of the song is in wait mode, the judgment result at Step SN12 is “YES”, and the CPU 14 proceeds to Step SN13. At Step SN13, the CPU 14 sets the end flag ENDF to “1” and completes the present process.

<When in Wait Mode>

When the training mode of the sound to which the user is currently being guided is set to wait mode by the ON-operation of the pedal 13, the judgment result at Step SN6 (see FIG. 19) is “YES”. The CPU 14 proceeds to Step SN7 and judges whether the end flag ENDF is “0”. In other words, the CPU 14 judges whether the end of the song is reached. When the end of the song is not reached, the judgment result is “YES”, and the CPU 14 proceeds to Step SN8. At Step SN8, the CPU 14 stops the timer (termination of the timer interrupt process) and completes the present process. Therefore, when the end of the song is not reached and the sound is in wait mode, the CPU 14 temporarily terminates the guide operation for guiding the user to the key to be played at the sounding timing. As described hereafter in the key-pressing process, the temporarily terminated guide operation is restarted upon the key to which the user is guided being properly pressed.

At the same time, when the end of the song is reached or, in other words, when the sound before the end of the song is in wait mode, the CPU 14 sets the end flag ENDF to “1” at Step SN13. Therefore, the judgment result at Step SN7 is “NO”. The CPU 14 proceeds to Step SN9 and resets the end flag ENDF to zero. Then, at Step SN14, the CPU 14 instructs the LED section 11 to turn off all LED mounted on each key on the keyboard 10. At the subsequent Step SN15, the CPU 14 stops the timer. Then, the CPU 14 proceeds to Step SN16, sets the start flag STF to “0” to set the start flag STF to the stop state and completes the present process.

In this way, in the guide process, when the sound is set to self-running mode by the OFF-operation of the pedal 13, the CPU 14 reads the song data (note, step, and time) of the next sound at the sounding timing of the previous sound. The CPU 14 illuminates only the LED of the key designated by the read note and guides the user to the key to be played. At the same time, when the sound is set to wait mode by the OFF-operation of the pedal 13, the CPU 14 temporarily terminates the guide operation for guiding the user to the key to be played at the sounding timing of the previous sound.

(e) Operations of the Key-Pressing Process

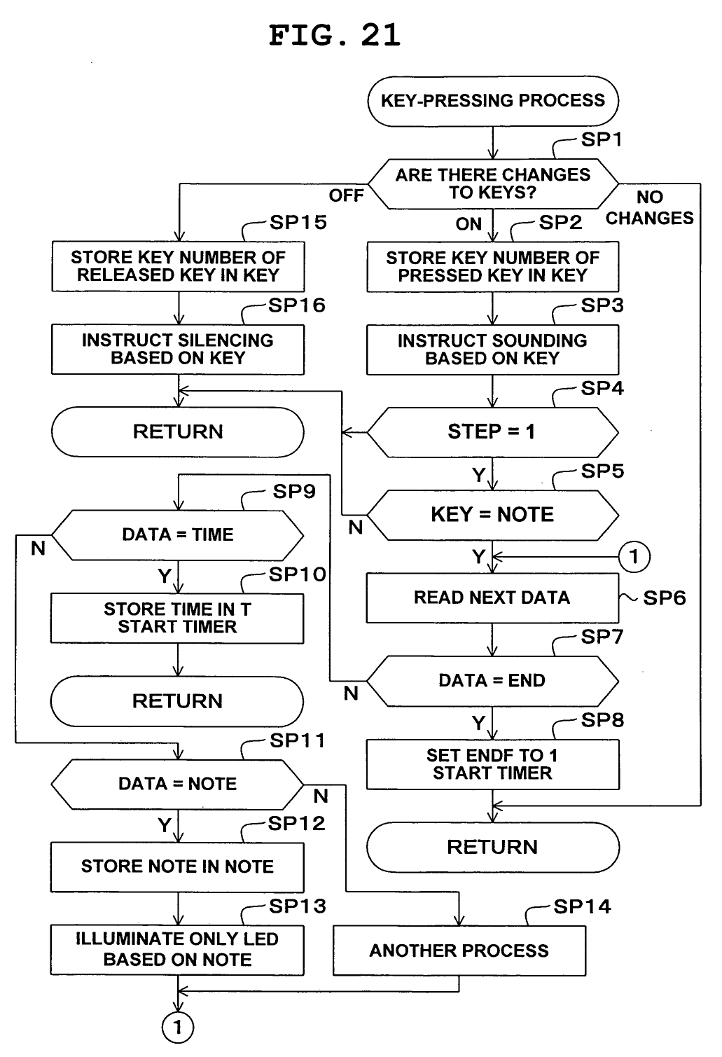

Next, the operations of the key-pressing process will be described with reference to FIG. 21. As in the first embodiment, when the present process is performed via Step SA4 of the main routine (see FIG. 3), the CPU 14 proceeds to Step SP1 shown in FIG. 21. At Step SP1, the CPU 14 determines changes to the keys based on the result of a key scanning performed on the keyboard 10. When the user has not pressed or released a key and no changes to the keys are generated at Step SP1, the CPU 14 completes the present process without performing any operations. At the same time, when a key-ON event according to the pressing of a key is generated at Step SP1, the CPU 14 performs the steps subsequent to Step SP2. When a key-OFF event according to the release of a key is generated, the CPU 14 performs Steps SP15 to SP16. Hereafter, the operations when a key is pressed and the operations when a key is released are separately described.

<When Key is Pressed>

When a key-ON event according to the pressing of a key is generated, the CPU 14 proceeds to Step SP2. At Step SP2, the CPU 14 stores the key number of the key that is being pressed in register KEY. Next, at Step SP3, the CPU 14 instructs the sound source 18 to sound the musical tone of the pitch corresponding to the key number stored in register KEY. Next, at Step SP4, the CPU 14 judges whether the value of the step stored in register STEP is “1”. In other words, the CPU 14 judges whether the training mode of the sound to which the user is currently being guided is wait mode. When the sound is in self-running mode, the judgment result is “NO”, and the CPU 14 completes the present process. In other words, in self-running mode, the CPU 14 only sounds the musical tone of the pitch designated by the pressed key and completes the present process. As a result, the training mode is that which the reading of the song data is successively continued, regardless of whether the key to which the user is guided as the key to be played in the afore-mentioned guide process (see FIG. 19 to FIG. 20) is pressed.

At the same time, when the sound is in wait mode, the judgment result at Step SP4 is “YES”. The CPU 14 proceeds to Step SP5 and judges whether the key number stored in register KEY and the note (key number) stored in register NOTE match. In other words, the CPU 14 judges whether the key to which the user is guided is pressed. When the key to which the user is guided is not pressed, the judgment result is “NO”, and the CPU 14 completes the present process. On the other hand, when the key to which the user is guided is pressed, the judgment result is “YES”. The CPU 14 proceeds to Step SP6 and reads the next data from the song data area of the RAM 16.

Next, at Step SP7, the CPU 14 judges whether the read data is the end data END indicating the end of the song. When the read data is not the end data END, the judgment result is “NO”, and the CPU 14 proceeds to Step SP9. At Steps SP9 to SP16, the processes corresponding to the data types read out in sequence from note to time are performed.

In other words, when the note within the event EVT is read, the judgment result at Step SP11 is “YES”. The CPU 14 proceeds to Step SP12 and stores the note in register NOTE. At the subsequent Step SP13, the CPU 14 instructs the LED section 11 to illuminate only the LED mounted on the key designated by the note (key number) stored in register NOTE. Then, the CPU 14 returns the process to Step SP6 and reads the next data. When the time TIME is read, the judgment result at Step SP9 is “YES”, and the CPU 14 proceeds to Step SP10. At Step SP10, the CPU 14 stores the time TIME in register T, starts the timer, and completes the present process.

When data other than the note is read from within the event EVT, for example, when an event data instructing a change in the musical tone is read, the respective judgment results at Step SP9 and SP11 are “NO”. The CPU 14 proceeds to Step SP14 and performs “another process” for instructing the sound source 18 to change the musical tone according to the event. Then, the CPU 14 returns the process to Step SP6 and reads the next data.

In this way, in wait mode, the CPU 14 continues reading the song data corresponding to the pressing of the key to which the user is guided. Then, when the read data is the end data END, the judgment result at Step SP7 is “YES”, and the CPU 14 proceeds to Step SP8. At Step SP8, the CPU 14 sets the end flag ENDF to “1”, starts the timer, and completes the present process.

<When Key is Released>

When a key-OFF event according to the pressing of a key is generated, the CPU 14 proceeds to Step SP15. At Step SP15, the CPU 14 stores the key number of the key that is released in register KEY. Next, at Step SP16, the CPU 14 instructs the sound source 18 to silence the musical tone of the pitch corresponding to the key number stored in register KEY and completes the present process.

As described above, according to the third embodiment, when the sound is set to self-running mode according to the OFF-operation of the pedal 13, the CPU 14 continues reading the song data, regardless of whether the key to which the user is guided by the illumination of the LED is pressed. At the same time, when the sound is set to wait mode according to the ON-operation of the pedal 13, the CPU 14 temporarily stops the song progression at the sounding timing (key-pressing timing) of the key to which the user is guided by the illumination of the LED. Then, the CPU 14 reads the song data of the next sound when the key to which the user is guided is pressed. Therefore, for example, if sounds within a song requiring simple key manipulations are set to self-running mode by the OFF-operation of the pedal 13 and sounds requiring difficult key manipulations are set to wait mode by the ON-operation of the pedal 13, even a beginner who is not used to key manipulations can receive musical performance training. As a result, the training mode can be set for each sound composing the song and detailed musical performance training can be actualized.

In the third embodiment, to simplify the explanation, the training mode is set to either one of self-running mode and wait mode depending on the ON/OFF operation of the pedal 13. However, an embodiment that provides a “timing practice mode” in addition to the two types of training modes is possible. In the “timing practice mode”, the reading of the song data of the next song is continued when the sounding timing of the key to which the user is guided and the timing of the key manipulation match.

Furthermore, although the computer program product for a musical performance training program which is a preferred embodiment of the present invention is stored in the memory (for example, ROM, etc.) of the musical performance training device, this processing program is stored on a computer-readable medium and should also be protected in the case of manufacturing, selling, etc. of only the program. In that case, the method of protecting the program with a patent will be realized by the form of the computer-readable medium on which the computer program product is stored.

While the present invention has been described with reference to the preferred embodiments, it is intended that the invention be not limited by any of the details of the description therein but includes all the embodiments which fall within the scope of the appended claims.

What is claimed is:

1. A musical performance training device comprising:
a song data storing means for storing song data indicating each sound composing a song and a training mode of each sound;
a reading means for reading the song data from the song data storing means according to an instructed reading mode;
a reading control means for instructing the reading means of a reading mode of a next song data according to the training mode indicated by the song data read by the reading means; and
a guiding means for guiding a user to a musical performance controller to be manipulated according to the song data read by the reading means.

2. A musical performance training device comprising:
a song data storing means for storing song data indicating a pitch and sounding timing of each sound composing a song and a training mode of each sound;
a reading means for reading the song data from the song data storing means according to a reading instruction;
a guiding means for guiding a user to a position and manipulation timing of a musical performance controller to be manipulated according to the pitch and sounding timing indicated by the song data read by the reading means;
a first reading control means for instructing the reading of a next song data, regardless of whether the manipulation of the musical performance controller to which the user is guided by the guiding means is performed, when the song data read by the reading means indicates a first training mode; and
a second reading control means for temporarily stopping the reading of the song data at a manipulation timing of the musical performance controller to which the user is guided by the guiding means and instructing the reading of a next song data according to the manipulation of the musical performance controller to which the user is guided, when the song data read by the reading means indicates a second training mode.

3. The musical performance training device according to claim 2, comprising:
a third reading control means for instructing the reading of the song data of the next sound when the musical performance controller to which the user is guided by the guiding means is manipulated at the manipulation timing, when the song data read by the reading means indicates a third training mode.

4. The musical performance training device according to claim 2, further comprising:
a musical score display means for transcribing the song data stored in the song data storing means into a musical score and displaying the musical score; and
a training mode setting means for setting a training mode of the song data of each sound included within a segment designated on the musical score displayed in the musical score display means.

5. The musical performance training device according to claim 4, comprising a reset means for resetting the training mode of all song data stored in the song data storing means to an initial state.

6. A musical performance training device comprising:
a song data storing means for storing song data indicating each sound composing a song;
a training mode designating means for designating a training mode according to user operation;
a reading means for reading the song data from the song data storing means according to an instructed reading mode;
a reading control means for instructing the reading means of the reading mode of the next song data according to the training mode designated by the training mode designating means; and
a guiding means for guiding a user to a musical performance controller to be manipulated according to the song data read by the reading means.

7. A musical performance training device comprising:
a song data storing means for storing song data indicating a pitch and sounding timing of each note composing a song;
a training mode designating means for designating either one of a first training mode and a second training mode according to user operation;
a reading means for reading the song data from the song data storing means according to a reading instruction;
a guiding means for guiding a user to a position and manipulation timing of a musical performance controller to be manipulated according to the pitch and sounding timing indicated by the song data read by the reading means;
a first reading control means for instructing the reading of a next song data, regardless of whether the manipulation of the musical performance controller to which the user is guided by the guiding means is performed, when the song data read by the reading means indicates a first training mode; and
a second reading control means for temporarily stopping the reading of the song data at a manipulation timing of the musical performance controller to which the user is guided by the guiding means and instructing the reading of a next song data according to the manipulation of the musical performance controller to which the user is guided, when the song data read by the reading means indicates a second training mode.

8. A musical performance training device comprising:
a song data storing means for storing song data indicating a pitch and sounding timing of each sound composing a song;
a training mode designating means for designating any one of a first to third training mode according to user operation;
a reading means for reading the song data from the song data storing means according to a reading instruction;
a guiding means for guiding a user to a position and manipulation timing of a musical performance controller to be manipulated according to the pitch and sounding timing indicated by the song data read by the reading means;
a first reading control means for instructing the reading of a next song data, regardless of whether the manipulation of the musical performance controller to which the user is guided by the guiding means is performed, when the song data read by the reading means indicates a first training mode;
a second reading control means for temporarily stopping the reading of the song data at a manipulation timing of the musical performance controller to which the user is guided by the guiding means and instructing the reading of a next song data according to the manipulation of the musical performance controller to which the user is guided, when the song data read by the reading means indicates a second training mode; and
a third reading control means for instructing the reading of the song data of the next sound when the musical performance controller to which the user is guided by the guiding means is manipulated at the manipulation timing, when the song data read by the reading means indicates a third training mode.

9. A computer program product for a musical performance training program stored on a computer-readable medium and executed by a computer, comprising the steps of:
a reading process for reading song data indicating each sound composing a song and a training mode of each sound, according to an instructed reading mode;
a reading control process for instructing the reading process of a reading mode of a next song data according to the training mode indicated by the song data read by the reading process; and
a guiding process for guiding a user to a musical performance controller to be manipulated according to the song data read by the reading process.

10. A computer program product for a musical performance training program stored on a computer-readable medium and executed by a computer, comprising the steps of:
a reading process for reading song data indicating a pitch and sounding timing of each sound composing a song and a training mode of each sound, according to a reading instruction;
a guiding process for guiding a user to a position and manipulation timing of a musical performance controller to be manipulated according to the pitch and sounding timing indicated by the song data read by the reading process;
a first reading control process for instructing the reading of a next song data, regardless of whether the manipulation of the musical performance controller to which the user is guided by the guiding process is performed, when the song data read by the reading process indicates a first training mode; and
a second reading control process for temporarily stopping the reading of the song data at a manipulation timing of the musical performance controller to which the user is guided by the guiding process and instructing the reading of a next song data according to the manipulation of the musical performance controller to which the user is guided, when the song data read by the reading process indicates a second training mode.

11. The computer program product for a musical performance training program according to claim 10, further comprising the step of:
a third reading control process for instructing the reading of the song data of the next sound when the musical performance controller to which the user is guided by the guiding process is manipulated at the manipulation timing, when the song data read by the reading process indicates a third training mode.

12. The computer program product for a musical performance training program according to claim 10, further comprising the steps of:
a musical score display process for transcribing the song data into a musical score and displaying the musical score; and
a training mode setting process for setting a training mode of the song data of each sound included within a segment designated on the musical score displayed in the musical score display process.

13. The computer program product for a musical performance training program according to claim 12, further comprising the steps of reset process for resetting the training mode of all song data stored to an initial state.

14. A computer program product for a musical performance training program stored on a computer-readable medium and executed by a computer, comprising the steps of:
a training mode designating process for designating a training mode according to user operation;
a reading process for reading song data indicating each sound composing a song, according to an instructed reading mode;
a reading control process for instructing the reading process of the reading mode of a next song data according to the training mode designated by the training mode designating process; and
a guiding process for guiding a user to a musical performance controller to be manipulated according to the song data read by the reading process.

15. A computer program product for a musical performance training program stored on a computer-readable medium and executed by a computer, comprising the steps of:
a training mode designating process for designating either one of a first training mode and a second training mode according to user operation;
a reading process for reading song data indicating a pitch and sounding timing of each note composing a song, according to a reading instruction;
a guiding process for guiding a user to a position and manipulation timing of a musical performance controller to be manipulated according to the pitch and sounding timing indicated by the song data read by the reading process;
a first reading control process for instructing the reading of a next song data, regardless of whether the manipulation of the musical performance controller to which the user is guided by the guiding process is performed, when the song data read by the reading process indicates a first training mode; and
a second reading control process for temporarily stopping the reading of the song data at a manipulation timing of the musical performance controller to which the user is guided by the guiding process and instructing the reading of a next song data according to the manipulation of the musical performance controller to which the user is guided, when the song data read by the reading process indicates a second training mode.

16. A computer program product for a musical performance training program stored on a computer-readable medium and executed by a computer, comprising the steps of:
a training mode designating process for designating any one of a first to third training mode according to user operation;
a reading process for reading song data indicating a pitch and sounding timing of each sound composing a song, according to a reading instruction;
a guiding process for guiding a user to a position and manipulation timing of a musical performance controller to be manipulated according to the pitch and sounding timing indicated by the song data read by the reading process;
a first reading control process for instructing the reading of a next song data, regardless of whether the manipulation of the musical performance controller to which the user is guided by the guiding process is performed, when the song data read by the reading process indicates a first training mode;
a second reading control process for temporarily stopping the reading of the song data at a manipulation timing of the musical performance controller to which the user is guided by the guiding process and instructing the reading of a next song data according to the manipulation of the musical performance controller to which the user is guided, when the song data read by the reading process indicates a second training mode; and
a third reading control process for instructing the reading of the song data of the next sound when the musical performance controller to which the user is guided by the guiding process is manipulated at the manipulation timing, when the song data read by the reading process indicates a third training mode.
